(19) United States
(12) Patent Application Publication
(10) Pub. No.: US 2026/0027465 A1
(43) Pub. Date: Jan. 29, 2026

(54) Virtual Object Selection Methods and Systems

(71) Applicant: Tencent Technology (Shenzhen) Company Limited, Shenzhen (CN)

(72) Inventors: Hangxing Zhao, Shenzhen (CN); Yuhua Liu, Shenzhen (CN)

(21) Appl. No.: 19/343,286

(22) Filed: Sep. 29, 2025

Related U.S. Application Data
(63) Continuation of application No. PCT/CN2024/120986, filed on Sep. 25, 2024.

(30) Foreign Application Priority Data
Dec. 8, 2023 (CN) 2023116922130

(51) Int. Cl. A63F 13/537

(52) U.S. Cl. CPC A63F 13/537

(57) ABSTRACT

This application discloses virtual object ban techniques within the field of computer technologies. The technique includes displaying a first page corresponding to a virtual object ban phase; receiving a request for ban assistance; and setting, in response to an end of the virtual object ban phase and when no ban operation for any virtual object is detected in the virtual object ban phase, a state of a virtual object corresponding to the request for ban assistance to a banned state. The method not only improves efficiency of banning a virtual object, but also ensures that a ban is made, so that the virtual object ban phase always results in a ban.

### CROSS-REFERENCE TO RELATED APPLICATIONS

This application is a Continuation of PCT Application No. PCT/CN2024/120986, filed Sep. 25, 2024, which claims priority to Chinese Patent Application No. 202311692213.0, each entitled “VIRTUAL OBJECT BAN METHOD AND APPARATUS, DEVICE, AND COMPUTER-READABLE STORAGE MEDIUM” filed on Dec. 8, 2023, and each of which is incorporated herein by reference in its entirety.

### FIELD

Aspects as described herein relate to the field of computer technologies, and in particular, to a virtual object ban method and apparatus, a device, and a computer-readable storage medium.

### BACKGROUND

With continuous development of computer technologies and game technologies, some games provide a virtual object ban phase. The virtual object ban phase is a phase of picking a virtual object that cannot appear in a game before the game starts.

### SUMMARY

Aspects as described herein provide a virtual object ban method and apparatus, a device, and a computer-readable storage medium. The technical solution includes:

According to an aspect, an aspect as described herein provides a virtual object ban method. The method includes:

A computer device displays a first page corresponding to a virtual object ban phase.

The computer device receives a request for ban assistance, the request for ban assistance being configured for requesting assistance in banning a virtual object corresponding to the request for ban assistance.

The computer device sets, in response to an end of the virtual object ban phase and when no ban operation for any virtual object is detected in the virtual object ban phase, a state of the virtual object corresponding to the request for ban assistance to a banned state, the virtual object in the banned state being unpickable in a virtual object pick phase.

According to another aspect, an aspect as described herein provides a virtual object ban apparatus. The apparatus includes:
ban phase;
a display module, configured to display a first page corresponding to a virtual object a determining module, configured to receive a ban aid request; and
a setting module, configured to set, in response to an end of the virtual object ban phase and when no ban operation for any virtual object is detected in the virtual object ban phase, a state of a virtual object corresponding to the request for ban assistance to a banned state, the virtual object in the banned state being unpickable in a virtual object pick phase.

According to another aspect, an aspect as described herein provides a computer device, the computer device including a processor and a memory, the memory having at least one piece of program code stored therein, and the at least one piece of program code being loaded and executed by the processor, to enable the computer device to implement any one of the foregoing virtual object ban methods.

According to another aspect, a computer-readable storage medium is further provided, the computer-readable storage medium having at least one piece of program code stored therein, and the at least one piece of program code being loaded and executed by a processor, to enable a computer to implement any one of the foregoing virtual object ban methods.

According to another aspect, a computer program or a computer program product is further provided, the computer program or the computer program product having at least one computer instruction stored therein, and the at least one computer instruction being loaded and executed by a processor, to enable a computer to implement any one of the foregoing virtual object ban methods.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a schematic diagram of an implementation environment of a virtual object ban method according to an aspect as described herein.

FIG. 2 is a flowchart of a virtual object ban method according to an aspect as described herein.

FIG. 3 is a schematic diagram of display of a matching page according to an aspect as described herein.

FIG. 4 is a schematic diagram of display of a first game page according to an aspect as described herein.

FIG. 5 is a schematic diagram of display of another first game page according to an aspect as described herein.

FIG. 6 is a schematic diagram of display of still another first game page according to an aspect as described herein.

FIG. 7 is a flowchart of a virtual object ban method according to an aspect as described herein.

FIG. 8 is a flowchart of a virtual object ban method according to an aspect as described herein.

FIG. 9 is a schematic diagram of a structure of a virtual object ban apparatus according to an aspect as described herein.

FIG. 10 is a schematic diagram of a structure of a terminal device according to an aspect as described herein.

FIG. 11 is a schematic diagram of a structure of a server according to an aspect as described herein.

### DETAILED DESCRIPTION

To make objectives, technical solutions, and advantages as described herein clearer, the following further describes implementations in detail with reference to the accompanying drawings.

The terms “first”, “second”, and so on as described herein are intended to distinguish similar objects but do not necessarily indicate a specific order or sequence. It is to be understood that such used terms are interchangeable where appropriate so that aspects as described herein described here can be implemented in an order other than those illustrated or described here. The implementations described in the following illustrative aspects do not represent all implementations consistent with this application. On the contrary, the implementations are merely examples of an apparatus and a method that are consistent with some aspects as described herein described in detail in claims.

With continuous development of computer technologies and game technologies, some games provide a virtual object ban phase. The virtual object ban phase is a phase of picking a virtual object that cannot appear in a game before the game starts.

In a related technology, a plurality of virtual objects that can be banned are displayed on a game page corresponding to the virtual object ban phase, a game player may pick one or several virtual objects from the plurality of virtual objects to ban, and the banned virtual object cannot appear in a subsequent game.

However, in the foregoing virtual object ban method, the game player needs to manually pick a virtual object that the player expects to ban, causing low efficiency of banning the virtual object. In addition, when the game player does not pick a virtual object on the game page corresponding to the virtual object ban phase to ban, a virtual object ban procedure is not complete enough, and game experience of the game player is further affected.

First, abbreviations and key terms involved in aspects as described herein are defined.

A virtual environment is an environment provided (or displayed) when an application program runs on a terminal device. The virtual environment refers to an environment created for virtual objects to perform activities. The virtual environment may be a two-dimensional virtual environment, a 2.5-dimensional virtual environment, a three-dimensional virtual environment, or the like. The virtual environment may be a simulated environment of the real world, may be a semi-simulated environment of the real world, or may be a completely fictional environment. For example, the virtual environment involved in aspects as described herein is a three-dimensional virtual environment.

A virtual object is a movable object in a virtual environment. The movable object may be a virtual person, a virtual animal, an anime person, or the like. A player may manipulate the virtual object by using a peripheral component or by tapping and touching a display screen. Each virtual object has a shape and size in the virtual environment, and occupies some space in the virtual environment. For example, when the virtual environment is a three-dimensional virtual environment, the virtual object is a three-dimensional model created based on a skeletal animation technology.

A third-person perspective is a perspective that a virtual camera is at a position behind a virtual object controlled by a player for a distance in a game, and the virtual object controlled by the player and all elements in a surrounding environment in a virtual environment may be seen.

First-person perspective: A game is played at a subjective perspective of a player.

A playing method of a multiplayer online battle arena (MOBA) game is: In a game battle, game equipment usually needs to be purchased, players participating in the game battle are divided into two game teams, and the two game teams compete with each other in a dispersed game map.

Ban/Pick (BP): Ban a virtual object refers to that the virtual object is banned from being used in a game battle, that is, the virtual object is banned in the game battle. Pick a virtual object refers to that the virtual object is picked in the game battle, that is, the virtual object is picked as a virtual object controlled by a computer device. Subsequently, the computer device can control the virtual object to participate in the game battle. A BP phase refers to that players participating in a game determine virtual objects that are banned from being used and virtual objects that the players expect to use.

A virtual object ban method provided in aspects as described herein is performed by the computer device. In some aspects, the computer device includes a terminal device or a server. FIG. 1 is a schematic diagram of an implementation environment of a virtual object ban method according to an aspect as described herein. As shown in FIG. 1, the implementation environment includes a terminal device 101 and a server 102.

A client that can provide a virtual environment is installed and run in the terminal device 101. The terminal device 101 is configured to perform the virtual object ban method according to this aspect as described herein.

The client that can provide the virtual environment is a game client or a client of another type, for example, the client that can provide the virtual environment is a third-person shooting (TPS) game client, a first-person shooting (FPS) game client, a multiplayer online battle arena (MOBA) game client, a multiplayer shooting survival game client, a massive multiplayer online role-playing game (MMO) client, an action role playing game (ARPG) client, a virtual reality (VR) client, an augmented reality (AR) client, a three-dimensional map program client, a map simulation program client, a social client, or an interactive entertainment client.

In some aspects, the terminal device 101 logs in, based on an account, to the client that can provide the virtual environment, and then performs, by using the client, the virtual object ban method provided in this aspect as described herein. The account is an account of a player corresponding to the terminal device 101, that is, the account also represents the player corresponding to the terminal device 101, and is equivalent to an object corresponding to the terminal device 101.

The server 102 is configured to provide a backend service for the client that can support the virtual environment. In a possible implementation, the server 102 takes on primary computing work, and the terminal device 101 takes on secondary computing work. Alternatively, the server 102 takes on secondary computing work, and the terminal device 101 takes on primary computing work. Alternatively, collaborative computing is performed between the server 102 and the terminal device 101 by using a distributed computing architecture.

In some aspects, the terminal device 101 is any electronic device product that performs human-computer interaction with a user in one or more manners such as a keyboard, a touchpad, a remote control, voice interaction, or a handwriting device. For example, the terminal device 101 is a smartphone, a tablet computer, a laptop computer, a desktop computer, a smart speaker, a smart watch, a personal computer (PC), a mobile phone, a personal digital assistant (PDA), a wearable device, a pocket PC (PPC), a smart on board unit, or a smart television.

The terminal device 101 may generally refer to one of a plurality of terminal devices. In this aspect, the terminal device 101 is merely used as an example for description. A person skilled in the art may learn that there may be more or fewer terminal devices 101. For example, there may be merely one terminal device 101, or there are dozens or hundreds of terminal devices 101, or more terminal devices. A quantity of terminal devices 101 and a device type are not limited in this aspect as described herein.

The server 102 is one server, or a server cluster formed by a plurality of servers, or any one of a cloud computing platform and a virtualization center. This is not limited in this aspect as described herein. The server 102 and the terminal device 101 may be directly or indirectly connected in a wired or wireless communication manner. The server 102 has a data receiving function, a data processing function, and a data transmitting function. Certainly, the server 102 may further have other functions. This is not limited in this aspect as described herein.

A person skilled in the art can understand that the terminal device 101 and the server 102 are merely examples, and other existing or future possible terminal devices or servers that are applicable to this application are also to be included in the scope of protection as described herein, and are included herein by reference.

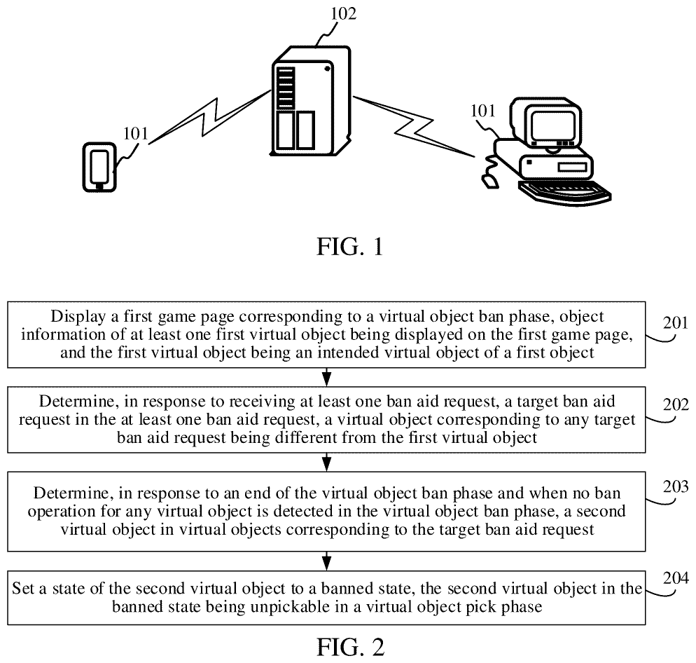

An aspect as described herein provides a virtual object ban method applicable to the foregoing implementation environment shown in FIG. 1. By using a flowchart of a virtual object ban method according to an aspect as described herein shown in FIG. 2 as an example, the method is performed by a computer device. That the computer device is the terminal device 101 in FIG. 1 is used as an example. As shown in FIG. 2, the method includes the following operation 201 to operation 204.

Operation 201: Display a first game page corresponding to a virtual object ban phase, object information of at least one first virtual object being displayed on the first game page, and the first virtual object being an intended virtual object of a first object.

In an illustrative aspect as described herein, that a client that can provide a virtual environment and that is installed and run in the terminal device is a game client is used as an example. The game client is a game client of any type. This is not limited in this aspect as described herein. In some aspects, the game client is a client that needs to be independently downloaded and installed, or is an embedded program that relies on a host program to run. The embedded program includes but is not limited to a mini program. A type of the game client is not limited in this aspect as described herein. The embedded program is an application program that is developed based on a programming language and that runs relying on the host program. The embedded program does not need to be downloaded and installed, but only needs to be dynamically loaded in the host program to run. A user finds a needed embedded program in a manner such as searching and scanning, which can be run and used by clicking/tapping, and does not occupy an internal memory of a terminal device after being used and closed. This is very convenient. In some aspects, the game client is a game client of a first-person perspective, or a game client of a third-person perspective. This is not limited in this aspect as described herein. In some aspects, the game client is a game client based on frame synchronization. That is, the virtual object ban method according to this aspect as described herein is applicable to a game client based on frame synchronization.

In a possible implementation, related information of the game client is displayed on a display interface of the terminal device. The related information of the game client is an icon of the game client, or a name of the game client, or other information of the game client. The related information of the game client is not limited in this aspect as described herein.

When the first object expects to run the game client, the first object picks the related information of the game client, the terminal device receives a pick operation for the related information of the game client, runs the game client, and displays a front page of the game client. A start control is displayed on the front page of the game client, and the start control is configured to start a round of game. In response to a trigger operation for the start control, a matching page is displayed. Object information of objects participating in the game is displayed on the matching page. The objects participating in the game include the first object, a second object, and a third object. A game team to which the second object belongs and a game team to which the first object belongs are the same, and a game team to which the third object belongs and the game team to which the first object belongs are different. The foregoing is described by using an example in which the second object and the first object belong to the same game team, and the third object and the first object belong to different game teams. In another aspect, the first object and the third object belong to a same game team, and the first object and the second object belong to different game teams. This is not limited as described herein. The foregoing is described by using an example in which the objects participating in the game include the first object, the second object, and the third object. In another aspect, the objects participating in the game further include another object, or the objects participating in the game include at least one of a plurality of second objects or a plurality of third objects.

The first object is an object corresponding to the terminal device, and is configured for representing a player corresponding to the terminal device. The second object and the third object are objects corresponding to other terminal devices, and are configured for representing players corresponding to the other terminal devices. That is, the first object, the second object, and the third object are configured for representing different players participating in the game. For example, an account used by the terminal device to log in is the object corresponding to the terminal device, and the first object is the account used by the terminal device to log in.

The object information displayed on the matching page is configured for representing an object that is about to participate in a same round of game. In this aspect as described herein, after a player triggers the start control by using the terminal device, the terminal device enters a matching phase, to match another player participating in a same round of game with the player. The terminal device can display, on the matching page, object information corresponding to the local player and object information corresponding to the matched another player. In this case, the object information displayed on the matching page is equivalent to a matching result. When all the objects represented by the object information displayed on the matching page agree with the current matching result, the objects represented by the object information displayed on the matching page subsequently participate in a same round of game. When the local object does not agree with the current matching result, the terminal device re-matches another player participating in a same round of game with the player, and re-displays object information of a matched object on the matching page.

In some aspects, the object information of the object participating in the game includes at least one of an object avatar or an object name of the object participating in the game. In some aspects, that the first object picks the related information of the game client is that the first object clicks/taps the related information of the game client, or that the first object picks the related information of the game client in a voice manner, or that the first object picks the related information of the game client in another manner. A manner in which the first object picks the related information of the game client is not limited in this aspect as described herein. In some aspects, the trigger operation for the start control is a click/tap operation for the start control, or another operation for the start control. The trigger operation for the start control is not limited in this aspect as described herein.

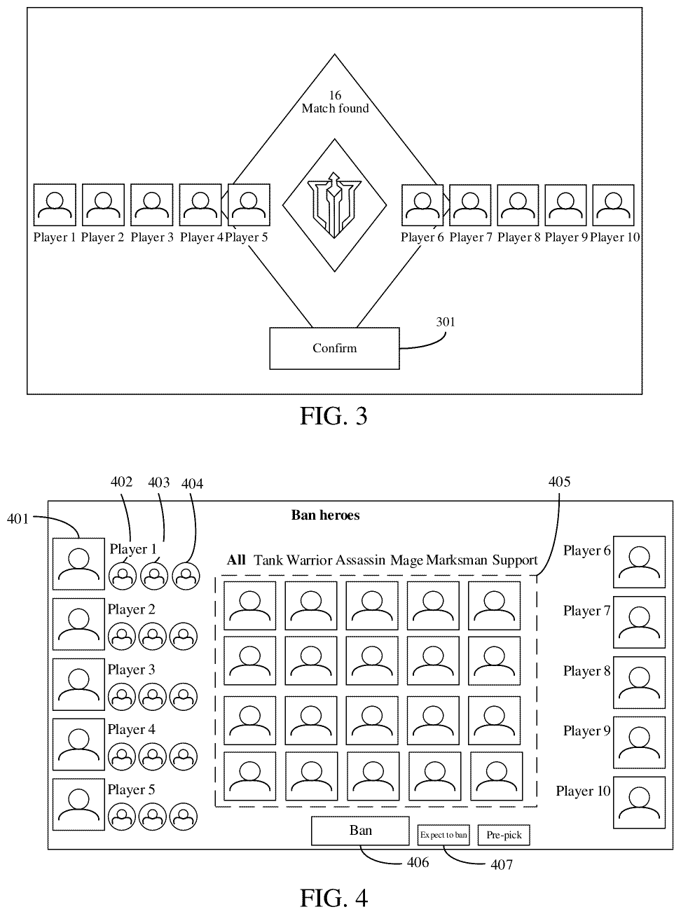

FIG. 3 is a schematic diagram of display of a matching page according to an aspect as described herein. On the matching page shown in FIG. 3, object avatars of objects participating in a game and object names of the objects participating in the game are displayed. For the object avatars and the object names of the objects participating in the game, refer to FIG. 3. Details are not described herein.

In some aspects, a countdown value is further displayed on the matching page, and the countdown value indicates remaining display duration of the matching page. As shown in FIG. 3, “16” is the countdown value, and “16” indicates that the matching page is to be displayed for 16 seconds. A confirmation control is further displayed on the matching page. As shown in FIG. 3, 301 is the confirmation control. When a terminal device displays the matching page, the player can pick the confirmation control by using the terminal device. In this case, the terminal device can detect a pick operation for the confirmation control, which indicates that the first object (that is, the player) is ready.

When each object participating in the game is ready, or countdown ends, the virtual object ban phase is entered, and the first game page corresponding to the virtual object ban phase is displayed. The object information of the at least one first virtual object is displayed on the first game page. The first virtual object is the intended virtual object of the first object, that is, the first virtual object is a virtual object that the first object expects to control in the game. The virtual object ban phase is a phase of picking a virtual object that cannot appear in a game before the game starts. The intended virtual object of the first object is also equivalent to a candidate virtual object of the first object, that is, a candidate virtual object of the terminal device corresponding to the first object. In this aspect as described herein, the first object represents the player corresponding to the terminal device, and the intended virtual object of the first object is equivalent to a virtual object that the player expects to control in a subsequent game battle when participating in the game battle by using the terminal device.

In some aspects, the object information of the first virtual object is an object avatar of the first virtual object, or an object name of the first virtual object, or other information of the first virtual object. This is not limited in this aspect as described herein. This aspect as described herein is described by using merely an example in which the object information of the first virtual object is the object avatar of the first virtual object.

FIG. 4 is a schematic diagram of display of a first game page according to an aspect as described herein. Based on that the first object is a player 1, 401, 402, 403, and 404 are object avatars of the first virtual object. To be specific, the first object expects to control a virtual object corresponding to the object avatar 401, a virtual object corresponding to the object avatar 402, a virtual object corresponding to the object avatar 403, and a virtual object corresponding to the object avatar 404 in the game.

In some aspects, object information of the first object is further displayed on the first game page, and the object information of the first object includes an object name of the first object. As shown in FIG. 4, “player 1” is the object name of the first object.

In some aspects, object information of an intended virtual object of each second object is further displayed on the first game page, that is, object information of a virtual object that each second object expects to control in the game. The object information of the virtual object that each second object expects to control in the game is shown in FIG. 4. For example, “player 2”, “player 3”, “player 4”, “player 5”, “player 6”, “player 7”, “player 8”, “player 9”, and “player 10” in FIG. 4 are equivalent to object names of second objects. An object avatar similar to the object avatar 401 below the object name of each second object is the object information of the intended virtual object of each second object.

In a possible implementation, object information of virtual objects that can be banned is further displayed on the first game page. As shown in FIG. 4, object avatars of the virtual objects that can be banned are displayed in 405. In response to a trigger operation for object information of any virtual object that can be banned and a triggered ban function, a state of any virtual object that can be banned is set to a banned state. A virtual object in a banned state cannot be picked, in a virtual object pick phase, by the object participating in the game. The object participating in the game is any object in any game team. For example, objects participating in a same round of game include the first object, the second object, and the third object. That is, the virtual object in the banned state cannot be picked, in the virtual object pick phase, by the first object, the second object, and the third object.

In some aspects, in response to the trigger operation for the object information of any virtual object that can be banned, triggered object information is displayed in a highlighted state.

In this aspect as described herein, the trigger operation for the object information of any virtual object that can be banned is equivalent to a pick operation for the object information. Therefore, if any piece of object information on the first game page is displayed in the highlighted state, it indicates that the object information is picked in this case. The trigger operation for the object information of any virtual object that can be banned is a click/tap operation for the object information of any virtual object that can be banned, or a double click/tap operation for the object information of any virtual object that can be banned. A trigger operation for a ban control is a click/tap operation for the ban control, or a double click/tap operation for the ban control. This is not limited in this aspect as described herein.

In some aspects, the ban control is further displayed on the first game page. As shown in FIG. 4, 406 is the ban control. In response to the trigger operation for the ban control, the ban function is triggered.

In some aspects, when the object information of any virtual object that can be banned is picked on the first game page, in response to the trigger operation for the ban control, a state of a virtual object represented by the picked object information is set to the banned state.

Any picked object information can be represented in any form. For example, the picked object information is displayed in the highlighted state.

In this aspect as described herein, only when the object information of any virtual object that can be banned is picked, the ban function can be triggered by using the ban control, to ban the picked virtual object, so that a state of the picked virtual object can be adjusted. This further ensures that the banned virtual object is a virtual object that the player expects to ban, thereby ensuring accuracy of banning a virtual object.

Operation 202: Determine, in response to receiving at least one ban aid request, a target ban aid request in the at least one ban aid request, a virtual object corresponding to any target ban aid request being different from the first virtual object.

In this aspect as described herein, one ban aid request corresponds to one virtual object, and any ban aid request indicates to request for assistance in banning a virtual object corresponding to the ban aid request. The ban aid request is also referred to as a request for ban assistance, and is configured for representing that another object participating in the same round of game requests assistance from the local object, and expects the local object to assist in banning the virtual object corresponding to the ban aid request.

In some aspects, the ban aid request is transmitted by another object. An example in which the object corresponding to the current terminal device is the first object is used, and the another object is a corresponding object participating in the same round of game with the first object.

For example, there are a plurality of objects participating in a same round of game, that is, there are a plurality of players participating in a same round of game, and any player in the plurality of players can transmit a ban aid request to terminal devices of other players by using a terminal device of the player.

In some aspects, the object corresponding to the terminal device is the first object, and the ban aid request received by the terminal device is transmitted by an object belonging to the same game team as the first object.

For example, there are 10 objects participating in a same round of game, the 10 objects are divided into two teams, each team includes 5 objects, the first object is an object in either of the teams, and another object in the team other than the first object can transmit a ban aid request to the terminal device corresponding to the first object by using a respective terminal device.

In a possible implementation, when having a virtual object ban permission, in response to receiving at least one ban aid request, the first object determines a virtual object corresponding to each ban aid request, and determines, in the at least one ban aid request, a ban aid request corresponding to a virtual object different from the first virtual object as the target ban aid request.

Some objects in the objects participating in the game have the virtual object ban permission, and some objects do not have the virtual object ban permission. Therefore, when having the virtual object ban permission and receiving the at least one ban aid request, the first object determines the target ban aid request in the at least one ban aid request.

In some aspects, the ban aid request includes object information of the virtual object corresponding to the ban aid request. Therefore, the virtual object corresponding to the ban aid request may be determined based on the object information included in the ban aid request.

For example, the first virtual object includes a virtual object 1, a virtual object 2, a virtual object 3, and a virtual object 4. The terminal device receives four ban aid requests. A virtual object corresponding to a 1^{st} ban aid request is the virtual object 1, a virtual object corresponding to a 2^{nd} ban aid request is a virtual object 5, a virtual object corresponding to a 3^{rd} ban aid request is a virtual object 6, and a virtual object corresponding to a 4^{th} ban aid request is the virtual object 4. Because the virtual object corresponding to the 2^{nd} ban aid request and the virtual object corresponding to the 3^{rd} ban aid request are different from the first virtual object, the 2^{nd} ban aid request and the 3^{rd} ban aid request are determined as target ban aid requests.

In some aspects, after the target ban aid request is determined, the terminal device displays a ban aid window corresponding to each target ban aid request, ban aid information is displayed in the ban aid window corresponding to the target ban aid request, and the ban aid information indicates to assist in banning a virtual object corresponding to the target ban aid request.

In this aspect as described herein, after ban aid requests are received, the target ban aid request is determined in the ban aid requests, to display the ban aid window corresponding to each target ban aid request, so that the player can view a ban aid request transmitted by another player, and a ban aid window corresponding to each ban aid request does not need to be displayed. This avoids that too many ban aid windows conflicting with a candidate virtual object of the local player are displayed and affect viewing of the player, thereby ensuring simplicity and accuracy of displayed content.

In some aspects, object information of the second object is further displayed on the first game page, and the target ban aid request includes object information of an object transmitting the target ban aid request. Before displaying the ban aid window corresponding to each target ban aid request, a display position of the ban aid window corresponding to each target ban aid request further needs to be determined. Processes of determining the display position of ban aid windows corresponding to target ban aid requests are the same. For any target ban aid request in the target ban aid requests, object information of an object transmitting the any target ban aid request is determined based on the any target ban aid request. A position corresponding to the object transmitting the any target ban aid request is determined as a display position of a ban aid window corresponding to the target ban aid request. That is, the ban aid window corresponding to the target ban aid request is displayed, based on the object information in the target ban aid request, at the position corresponding to the object transmitting the target ban aid request.

In this aspect as described herein, the object corresponding to the terminal device is the first object, the object participating in the same round of game with the first object includes the second object, the object information of the second object is displayed on the first game page, and the second object includes the object transmitting the target ban aid request. For any target ban aid request, based on object information that is in the target ban aid request and that corresponds to an object transmitting the target ban aid request, object information included in the target ban aid request can be determined from the object information displayed on the first game page, and then a position corresponding to the object transmitting the target ban aid request can be determined, so that a ban aid window corresponding to the target ban aid request is displayed at the position.

In some aspects, a display position of the object information of the object transmitting the target ban aid request is determined as a display position of the ban aid window corresponding to the target ban aid request. That is, based on the object information in the target ban aid request, the ban aid window corresponding to the target ban aid request is displayed at the display position of the object information included in the target ban aid request on the first game page.

In this aspect as described herein, because the object information of the object transmitting the target ban aid request is displayed on the first game page, on the first game page, the ban aid window corresponding to the target ban aid request is displayed at the display position of the object information of the object transmitting the target ban aid request, so that when viewing the first game page, the player can learn who transmits content in each ban aid window, thereby improving a page display effect.

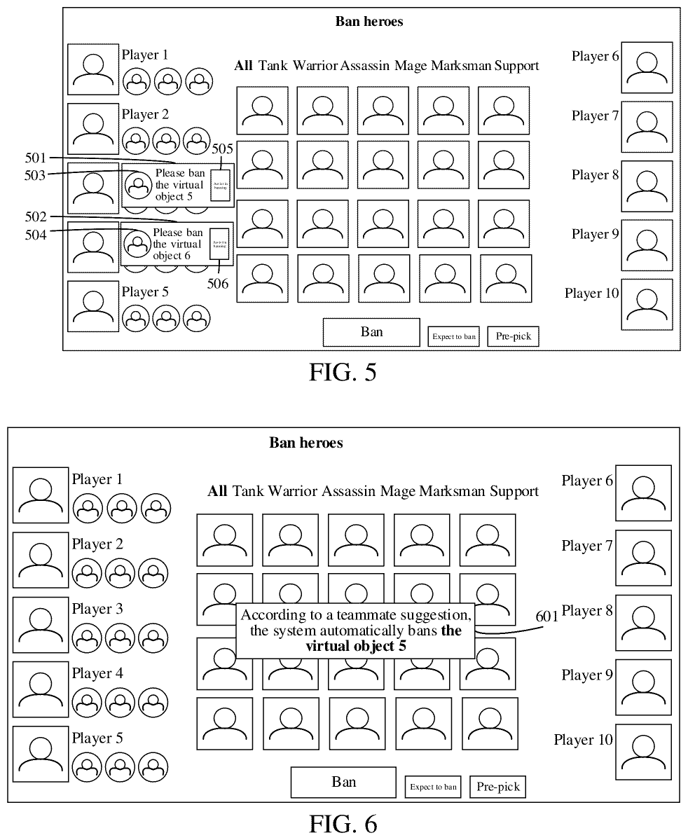

FIG. 5 is a schematic diagram of display of another first game page according to an aspect as described herein. A ban aid window 501 corresponding to the 2^{nd} ban aid request and a ban aid window 502 corresponding to the 3^{rd} ban aid request are displayed on the first game page shown in FIG. 5. An object transmitting the 2^{nd} ban aid request is the player 3, and an object transmitting the 3^{rd} ban aid request is the player 4. Therefore, the ban aid window 501 corresponding to the 2^{nd} ban aid request is displayed at a position corresponding to the player 3, and the ban aid window 502 corresponding to the 3^{rd} ban aid request is displayed at a position corresponding to the player 4. Ban aid information displayed in the ban aid window 501 is “Please ban the virtual object 5”, to indicate to assist in banning the virtual object 5. Ban aid information displayed in the ban aid window 502 is “Please ban the virtual object 6”, to indicate to assist in banning the virtual object 6.

In some aspects, object information of a virtual object corresponding to each target ban aid request is further displayed in the ban aid window corresponding to each target ban aid request. As shown in FIG. 5, an object avatar 503 is displayed in the ban aid window 501 corresponding to the 2^{nd} ban aid request. The object avatar 503 is configured for representing the virtual object corresponding to the 2^{nd} ban aid request, that is, a virtual object for which the 2^{nd} ban aid request requests for ban assistance. An object avatar 504 is displayed in the ban aid window 502 corresponding to the 3^{rd} ban aid request. The object avatar 504 is configured for representing the virtual object corresponding to the 3^{rd} ban aid request, that is, a virtual object for which the 3^{rd} ban aid request requests for ban assistance.

In this aspect as described herein, the object information of the virtual object corresponding to the ban aid request is displayed in the ban aid window corresponding to the ban aid request, so that the player can learn of, by viewing the ban aid window, the virtual object that the ban aid request expects to ban, thereby enriching information included in the ban aid window, and improving a display effect of the ban aid window.

In some aspects, a ban aid control is further displayed in the ban aid window corresponding to each target ban aid request. As shown in FIG. 5, a ban aid control 505 is displayed in the ban aid window 501 corresponding to the 2^{nd} ban aid request, and a ban aid control 506 is displayed in the ban aid window 502 corresponding to the 3^{rd} ban aid request. In response to a trigger operation for a ban aid control displayed in a ban aid window corresponding to any target ban aid request, a state of a virtual object corresponding to the any target ban aid request is set to the banned state. A virtual object in a banned state is unpickable, in the virtual object pick phase, by objects in the game team participating in the game, that is, the virtual object in the banned state cannot be picked, in the virtual object pick phase, by the first object, the second object, and the third object.

In this aspect as described herein, the ban aid control is displayed in the ban aid window. The virtual object may be banned based on content in the ban aid window through the trigger operation for the ban aid control, and the player does not need to perform a complex operation. This ensures convenience of banning the virtual object, and further improves human-computer interaction efficiency.

For example, based on the first game page shown in FIG. 5, the terminal device sets, in response to a trigger operation for the ban aid control 505 displayed in the ban aid window 501, a state of the virtual object 5 to the banned state. That is, in the virtual object pick phase, the object in the game team participating in the game cannot pick the virtual object 5.

In some aspects, a ban aid window corresponding to a candidate ban aid request is further displayed on the first game page. The candidate ban aid request is a ban aid request in the at least one ban aid request other than the target ban aid request. A display process of a ban aid window corresponding to the candidate ban aid request is similar to a display process of the ban aid window corresponding to the target ban aid request, and content displayed in the ban aid window corresponding to the candidate ban aid request is similar to content displayed in the ban aid window corresponding to the target ban aid request. That is, the display process of the ban aid window corresponding to the target ban aid request is similar to a display process of a ban aid window corresponding to each ban aid request. Details are not described herein again.

The foregoing is described by using an example in which the target ban aid request is determined from the at least one received ban aid request. In another aspect, when receiving a ban aid request, the terminal device displays a ban aid window corresponding to the ban aid request on the first game page. Ban aid information is displayed in the ban aid window, and the ban aid information indicates to ban a virtual object corresponding to the ban aid request. In this aspect as described herein, when receiving one or more ban aid requests, the terminal device can display a ban aid window corresponding to each ban aid request on the first game page.

In this aspect as described herein, the candidate virtual object of the local object is merely a virtual object that the player may expect to pick to participate in a subsequent battle, but the player does not necessarily pick the candidate virtual object. Therefore, for each received ban aid request, a ban aid window corresponding to each ban aid request can be displayed, to display related content of each ban aid request, so that the player learns of the content of each ban aid request, enriching content displayed on the first game page, avoiding omitting a received ban aid request, ensuring a display effect of the first page, and ensuring accuracy of information display. In addition, for the candidate ban aid request, the player can also weigh whether to ban a virtual object for the candidate ban aid request, thereby improving strategy of the game, and further improving experience of the player.

In some aspects, object information of each object participating in the battle is displayed on the first game page, and each ban aid request includes object information of an object transmitting the ban aid request. For each received ban aid request, a ban aid window corresponding to the ban aid request is displayed, based on object information in the ban aid request, at a position corresponding to the object transmitting the ban aid request.

In this aspect as described herein, a corresponding ban aid window is displayed at a position corresponding to an object transmitting each ban aid request, to ensure that a displayed ban aid window corresponds to each object, so that the player learns of an object from which content of each ban aid window is transmitted. This ensures a display effect of the first game page, and also ensures display accuracy of the ban aid window.

In some aspects, a display position of object information of an object transmitting a ban aid request is displayed on the first page, and a ban aid window corresponding to the ban aid request is displayed.

In this aspect as described herein, because the object information of the object transmitting the ban aid request is displayed on the first game page, on the first game page, the ban aid window corresponding to the ban aid request is displayed at the display position of the object information of the object transmitting the ban aid request, so that when viewing the first game page, the player can learn who transmits content in each ban aid window, thereby improving a page display effect.

In some aspects, when one ban aid request is received, and a virtual object corresponding to the ban aid request is different from the first virtual object, in response to an end of the virtual object ban phase and when no ban operation for any virtual object is detected in the virtual object ban phase, a state of the virtual object corresponding to the ban aid request is set to the banned state.

In some aspects, when one ban aid request is received, and a virtual object corresponding to the ban aid request is the same as the first virtual object, in response to an end of the virtual object ban phase and when no ban operation for any virtual object is detected in the virtual object ban phase, a subsequent processing process is the same as a processing process in the following operation 204 in response to that the ban aid request is not received and when no ban operation for any virtual object is detected in the virtual object ban phase and the virtual object ban phase ends. Details are not described herein.

Operation 203: Determine, in response to the end of the virtual object ban phase and when no ban operation for any virtual object is detected in the virtual object ban phase, a second virtual object in virtual objects corresponding to the target ban aid request.

In this aspect as described herein, in the virtual object ban phase, the player can trigger a ban operation for any virtual object by using the terminal device, to ban a triggered virtual object. In addition, after the end of the virtual object ban phase, the player can no longer ban a virtual object. The terminal device detects no ban operation for any virtual object in the virtual object ban phase, and the player does not manually ban a virtual object in the virtual object ban phase. In response to the end of the virtual object ban phase and when no ban operation for any virtual object is detected in the virtual object ban phase, and because in this case the player cannot trigger a ban operation for any virtual object by using the terminal device, the terminal device bans a virtual object based on the received ban aid request, and then determines the second virtual object in the virtual objects corresponding to the target ban aid request, so as to subsequently ban the second virtual object.

In this aspect as described herein, in response to the end of the virtual object ban phase and when no ban operation for any virtual object is received, that is, when the first object does not manually ban a virtual object, the second virtual object is determined in the virtual objects corresponding to the target ban aid request.

In this aspect as described herein, a process of determining the second virtual object in the virtual objects corresponding to the target ban aid request includes the following two cases.

Case 1: When the received ban aid request includes one target ban aid request, a virtual object corresponding to the target ban aid request is determined as the second virtual object.

For example, the virtual object corresponding to the target ban aid request is the virtual object 5. Therefore, the virtual object 5 is determined as the second virtual object.

Case 2: When the received ban aid request includes a plurality of target ban aid requests, a quantity of times of requesting for ban aid of a virtual object corresponding to each target ban aid request is determined. When there is one virtual object whose quantity of times of requesting for ban aid meets a first quantity of times requirement, the virtual object whose quantity of times of requesting for ban aid meets the first quantity of times requirement is determined as the second virtual object. When there are a plurality of virtual objects whose quantities of times of requesting for ban aid meet the first quantity of times requirement, the second virtual object is determined in the virtual objects whose quantities of times of requesting for ban aid meet the first quantity of times requirement.

The quantity of times of requesting for ban aid of the virtual object is a quantity of times of requesting to ban the virtual object. In some aspects, the quantity of times of requesting for ban aid is determined based on a historical ban aid request. In this aspect as described herein, each ban aid request indicates to assist in banning a virtual object, and different ban aid requests may indicate a same virtual object or different virtual objects. Based on a virtual object corresponding to the historical ban aid request, a quantity of times of requesting to ban each virtual object can be determined. The virtual object whose quantity of times of requesting for ban aid meets the first quantity of times requirement is a virtual object whose quantity of times of requesting for ban aid is largest. That is, the first quantity of times requirement indicates a largest quantity of times of requesting for ban aid in a plurality of quantities of times of requesting for ban aid.

In this aspect as described herein, because the received ban aid request includes one or more target ban aid requests, a virtual object to be banned can be determined in different manners based on a quantity of target ban aid requests, so that different situations in the game can be met, and feasibility of banning the virtual object can be ensured. In addition, when a plurality of target ban aid requests are included, a quantity of times of requesting for ban aid of the virtual object is considered, and the quantity of times of requesting for ban aid can reflect willingness of the player to ban a virtual object. It can be ensured as much as possible that a determined virtual object is a virtual object that the player participating in the game most likely expects to ban, and it can be ensured that an automatically banned virtual object meets a requirement of the player, thereby improving experience of the player.

In some aspects, a process of determining the second virtual object in the virtual objects whose quantities of times of requesting for ban aid meet the first quantity of times requirement includes: determining any virtual object in the virtual objects whose quantities of times of requesting for ban aid meet the first quantity of times requirement as the second virtual object; or determining a quantity of times of ban of the virtual object whose quantity of times of requesting for ban aid meets the first quantity of times requirement, and determining a virtual object whose quantity of times of ban meets a second quantity of times requirement as the second virtual object.

The quantity of times of ban of the virtual object is a quantity of times of banning the virtual object. In some aspects, the quantity of times of ban of the virtual object is determined based on historical battle information. In this aspect as described herein, a virtual object is banned in a historical battle, and a virtual object banned in each historical battle can be determined based on the historical battle information, so that a quantity of times of ban of each virtual object can be determined. The virtual object whose quantity of times of ban meets the second quantity of times requirement is a virtual object whose quantity of times of ban is largest. That is, the second quantity of times requirement indicates a largest quantity of times of ban in a plurality of quantities of times of ban.

In this aspect as described herein, because there are one or more virtual objects whose quantities of times of requesting for ban aid meet the first quantity of times requirement, a virtual object to be banned can be determined in different manners, so that different situations in the game can be met, and feasibility of banning the virtual object can be ensured. In addition, considering a quantity of times of ban of a virtual object, the quantity of times of ban can reflect a situation of banning a virtual object. It can be ensured as much as possible that a determined virtual object is a virtual object that the player participating in the game most likely expects to ban, and it can be ensured that an automatically banned virtual object meets a requirement of the player, thereby improving experience of the player.

In some aspects, a process of determining the quantity of times of ban of the virtual object whose quantity of times of requesting for ban aid meets the first quantity of times requirement includes: transmitting a quantity of times of ban obtaining request to a server, the quantity of times of ban obtaining request including an object identifier of the virtual object whose quantity of times of requesting for ban aid meets the first quantity of times requirement. The server stores a quantity of times of ban of each virtual object and a correspondence, and the correspondence is a correspondence between an object identifier of each virtual object and the quantity of times of ban of each virtual object. The server receives the quantity of times of ban obtaining request, parses the quantity of times of ban obtaining request, to obtain the object identifier of the virtual object whose quantity of times of requesting for ban aid meets the first quantity of times requirement, and determine, based on the object identifier of the virtual object whose quantity of times of requesting for ban aid meets the first quantity of times requirement and the correspondence, the quantity of times of ban of the virtual object whose quantity of times of requesting for ban aid meets the first quantity of times requirement. The server returns, to the terminal device, the quantity of times of ban of the virtual object whose quantity of times of requesting for ban aid meets the first quantity of times requirement, so that the terminal device obtains the quantity of times of ban of the virtual object whose quantity of times of requesting for ban aid meets the first quantity of times requirement.

For example, there are two target ban aid requests, respectively, the 2^{nd} ban aid request and the 3^{rd} ban aid request. The virtual object corresponding to the 2^{nd} ban aid request is the virtual object 5, and the virtual object corresponding to the 3^{rd} ban aid request is the virtual object 6. A quantity of times of requesting for ban aid of the virtual object 5 is 100, and a quantity of times of requesting for ban aid of the virtual object 6 is 80. Because the quantity of times of requesting for ban aid of the virtual object 5 is larger, the virtual object 5 is determined as the second virtual object.

For another example, there are two target ban aid requests, respectively, the 2^{nd} ban aid request and the 3^{rd} ban aid request. The virtual object corresponding to the 2^{nd} ban aid request is the virtual object 5, and the virtual object corresponding to the 3^{rd} ban aid request is the virtual object 6. The virtual object 5 and the virtual object 6 have a same quantity of times of requesting for ban aid. Therefore, a quantity of times of ban of the virtual object 5 and a quantity of times of ban of the virtual object 6 are determined. The quantity of times of ban of the virtual object 5 is 150, and the quantity of times of ban of the virtual object 6 is 180. Because the quantity of times of ban of the virtual object 6 is larger, the virtual object 6 is determined as the second virtual object.

This aspect as described herein is described by using an example in which the target ban aid request is determined in response to receiving at least one ban aid request. In another aspect, the foregoing operation 202 and operation 203 do not need to be performed, and other manners are used. The terminal device receives at least one ban aid request in the virtual object ban phase, determines, in response to the end of the virtual object ban phase and when no ban operation for any virtual object is detected in the virtual object ban phase, the target ban aid request from the at least one ban aid request, and determines the second virtual object in virtual objects corresponding to the target ban aid request.

In this aspect as described herein, the terminal receives only the ban aid request in the virtual object ban phase, and does not determine the target ban aid request from the ban aid request. The terminal determines the target ban aid request from the received ban aid request only when the virtual object ban phase is about to end and no ban operation for any virtual object is detected, and then determines the second virtual object. This avoids a case in which the terminal device still determines the target ban aid request when the player triggers a ban operation for any virtual object by using the terminal device, avoids waste of resources of the terminal device, saving resources of the terminal device.

Operation 204: Set a state of the second virtual object to the banned state, the second virtual object in the banned state being unpickable in the virtual object pick phase.

In this aspect as described herein, the virtual object in the banned state is unpickable in the virtual object pick phase. After the state of the second virtual object is set to the banned state, the second virtual object is unpickable in the virtual object pick phase. After the second virtual object is determined in the foregoing operation 203, the state of the second virtual object is set to the banned state. The second virtual object in the banned state is unpickable in the virtual object pick phase. That is, the second virtual object in the banned state cannot be picked, in the virtual object pick phase, by the first object, the second object, and the third object. The game team to which the second object belongs and the game team to which the first object belongs are the same, and the game team to which the third object belongs and the game team to which the first object belongs are different.

In some aspects, after the state of the second virtual object is set to the banned state, first prompt information may be further displayed, the first prompt information indicating that the second virtual object is banned. Content of the first prompt information may be any content. This is not limited in this aspect as described herein.

In this aspect as described herein, after the state of the second virtual object is set to the banned state, the first prompt information is displayed, to prompt that the second virtual object is banned, so that the player can learn of a current situation of banning a virtual object, thereby enriching content displayed on the page, and improving experience of the player.

FIG. 6 is a schematic diagram of display of still another first game page according to an aspect as described herein. First prompt information 601 is displayed on the first game page shown in FIG. 6. Content included in the first prompt information 601 is “According to a teammate suggestion, the system automatically bans the virtual object 5”.

In this aspect as described herein, in this ban aid manner, when the first object leaves, switches a screen, forgets to ban a virtual object, or the like, the virtual object may be banned with the assistance of a teammate. Because a virtual object that the teammate requests to ban is a virtual object that the teammate expects to ban, or is a virtual object that has a great threat to the game team to which the first object belongs, a degree of cooperation between objects in the game team can be improved, thereby improving game experience of the game object. In addition, blank ban of a virtual object does not occur, so that the virtual object ban phase is more complete.

In a possible implementation, the object information of the virtual objects that can be banned is further displayed on the first game page. As shown in FIG. 4, the object avatars of the virtual objects that can be banned are displayed in 405. After the first game page corresponding to the virtual object ban phase is displayed, in response to the end of the virtual object ban phase and when the ban aid request is not received and no ban operation for any virtual object is detected in the virtual object ban phase, a third virtual object is determined in the virtual objects that can be banned, and a state of the third virtual object is set to the banned state, the third virtual object in the banned state being unpickable in the virtual object pick phase.

In this aspect as described herein, when the first object leaves, switches a screen, or forgets to ban a virtual object, a teammate does not assist in banning a virtual object, or the like, a virtual object is automatically banned for the first object, to avoid a case in which blank ban of a virtual object occurs, so that the virtual object ban phase is more complete, thereby improving game experience of the player.

In some aspects, a process of determining the third virtual object in the virtual objects that can be banned includes: using virtual objects other than the first virtual object in the virtual objects that can be banned as candidate banned virtual objects; and determining any candidate banned virtual object as the third virtual object; or determining a candidate banned virtual object whose quantity of times of ban meets a third quantity of times requirement as the third virtual object.

The candidate banned virtual object whose quantity of times of ban meets the third quantity of times requirement is a candidate banned virtual object whose quantity of times of ban is largest. Before the candidate banned virtual object whose quantity of times of ban meets the third quantity of times requirement is determined as the third virtual object, a quantity of times of ban of each candidate banned virtual object needs to be first determined. A process of determining the quantity of times of ban of each candidate banned virtual object is similar to the foregoing process of determining the quantity of times of ban of the virtual object whose quantity of times of requesting for ban aid meets the first quantity of times requirement. Details are not described herein again in this aspect as described herein.

In this aspect as described herein, when there is one candidate banned virtual object whose quantity of times of ban meets the third quantity of times requirement, the candidate banned virtual object whose quantity of times of ban meets the third quantity of times requirement is determined as the third virtual object. When there are a plurality of candidate banned virtual objects whose quantities of times of ban meet the third quantity of times requirement, any candidate banned virtual object in the candidate banned virtual objects whose quantities of times of ban meet the third quantity of times requirement is determined as the third virtual object.

In this aspect as described herein, when the first object leaves, switches a screen, or forgets to ban a virtual object, a teammate does not assist in banning a virtual object, or the like, a virtual object can be automatically banned for the first object in any one of a plurality of manners, to avoid a case in which blank ban of a virtual object occurs, so that the virtual object ban phase is more complete, thereby improving game experience of the player. In addition, when a virtual object is banned, the quantity of times of ban of the candidate banned virtual object can be considered, to ensure that the banned virtual object can meet a requirement of the player, thereby improving experience of the player.

For example, the virtual objects that can be banned include the virtual object 1 to a virtual object 10, and the first virtual object includes the virtual object 1 to the virtual object 4. Therefore, the virtual object 5 to the virtual object 10 are used as the candidate banned virtual objects. Any one of the virtual object 5 to the virtual object 10 is determined as the third virtual object. Alternatively, a quantity of times of ban of each of the virtual object 5 to the virtual object 10 is determined, and a quantity of times of ban of a virtual object 7 is largest. Therefore, the virtual object 7 is determined as the third virtual object. Alternatively, when a quantity of times of ban of a virtual object 7 and a quantity of times of ban of a virtual object 8 are largest, either of the virtual object 7 and the virtual object 8 is determined as the third virtual object.

In some aspects, before the matching page is displayed, a virtual object ban page may be further displayed. Object information of a plurality of candidate virtual objects is displayed on the virtual object ban page. In response to a trigger operation for the object information of at least one candidate virtual object, the at least one triggered candidate virtual object is determined as a virtual object that the first object expects to ban. In response to the end of the virtual object ban phase and when the ban aid request is not received and no ban operation for any virtual object is detected in the virtual object ban phase, the target virtual object is determined in virtual objects that the first object expects to ban, and the state of the target virtual object is adjusted to the banned state.

A process of determining the target virtual object in the virtual objects that the first object expects to ban includes: When there is one virtual object that the first object expects to ban, determining the virtual object that the first object expects to ban as the target virtual object; and when there are a plurality of virtual objects that the first object expects to ban, determining a quantity of times of ban of each virtual object that the first object expects to ban, and determining a virtual object whose quantity of times of ban is largest in the virtual objects that the first object expects to ban as the target virtual object.

In a possible implementation, when the first object does not have the virtual object ban permission, after the first game page is displayed, the first object may transmit a ban aid request of the first object to an object having the virtual object ban permission, so that the object having the virtual object ban permission assists the first object in banning the virtual object. In some aspects, a process of transmitting the ban aid request of the first object by the first object to the object having the virtual object ban permission includes: displaying the object information of the virtual objects that can be banned on the first game page, as shown in FIG. 4, the object information of the virtual objects that can be banned is displayed in 405; and in response to the trigger operation for the object information of any virtual object that can be banned and the triggered ban aid operation, transmitting the object information of any virtual object that can be banned to the server, so that the server generates the ban aid request of the first object based on the object information of any virtual object that can be banned and the object information of the first object, and transmits the ban aid request of the first object to the object having the virtual object ban permission.

The ban aid request of the first object includes the object information of the first object and object information of a virtual object that can be banned and that is triggered by the first object.

In this aspect as described herein, the trigger operation for the object information of any virtual object that can be banned and the triggered ban aid operation indicate that the player expects a teammate to assist in banning the virtual object. The terminal device interacts with the server, and the server transmits the ban aid request to a terminal device corresponding to a teammate having the virtual object ban permission.

In some aspects, a control of expected ban is further displayed on the first game page. As shown in FIG. 4, 407 is the control of expected ban. In response to a trigger operation for the control of expected ban, a ban aid operation is triggered.

In a possible implementation, in response to receiving at least one ban aid request, there is no target ban aid request corresponding to a virtual object different from the first virtual object in the at least one ban aid request, in response to the end of the virtual object ban phase, and when no ban operation for any object is detected in the virtual object ban phase, the third virtual object is determined in the virtual objects that can be banned, and the state of the third virtual object is set to the banned state.

In a possible implementation, after the end of the virtual object ban phase, the virtual object pick phase is entered, and in the virtual object pick phase, each object participating in the game needs to pick a virtual object controlled in the game. A second game page corresponding to the virtual object pick phase is displayed. The object information of the at least one first virtual object is displayed in the second game picture. In response to receiving at least one pick aid request, a target pick aid request in the at least one pick aid request is determined, and the at least one first virtual object includes a virtual object corresponding to the target pick aid request. In response to an end of the virtual object pick phase and when no pick operation for any virtual object is detected in the virtual object pick phase, a fourth virtual object is determined in virtual objects corresponding to the target pick aid request. The fourth virtual object is used as a virtual object controlled by the first object in the game. The virtual object controlled by the first object in the game is a virtual object controlled by the terminal device.

In this aspect as described herein, in this pick aid manner, when the first object leaves, switches a screen, forgets to pick a virtual object, or the like, a virtual object may be picked with the assistance of a teammate. Because in a manner of assisting in picking a virtual object by the teammate, development of an entire game team is considered, a degree of cooperation between objects in the game team can be improved, thereby improving game experience of the game object.

In some aspects, the pick aid request includes object information of a virtual object picked through assistance, and the pick aid request is parsed to obtain the virtual object corresponding to the pick aid request. A pick aid request in a plurality of pick aid requests whose corresponding virtual object is the same as the first virtual object is determined as the target pick aid request.

In this aspect as described herein, in response to the end of the virtual object pick phase and when no pick operation for any virtual object is detected in the virtual object pick phase, that is, when the first object does not manually pick a virtual object, the fourth virtual object is determined in the virtual objects corresponding to the target pick aid request.

In some aspects, when the pick aid request includes one target pick aid request, a virtual object corresponding to the target pick aid request is used as the fourth virtual object. When the pick aid request includes a plurality of target pick aid requests, a quantity of times of using of a virtual object corresponding to each target pick aid request is determined, and a virtual object whose quantity of times of using meets a fourth quantity of times requirement is used as the fourth virtual object. The virtual object whose quantity of times of using meets the fourth quantity of times requirement is a virtual object whose quantity of times of using is largest.

The quantity of times of using of the virtual object is a quantity of times of using the virtual object. In some aspects, the quantity of times of using of the virtual object is determined based on the historical battle information. In this aspect as described herein, virtual objects are used in a historical battle. That is, the player controls, in a virtual battle by using the terminal device, the virtual object to interact with other virtual objects. A virtual object used in each historical battle can be determined based on the historical battle information, and further, a quantity of times of using of each virtual object can be determined. The virtual object whose quantity of times of using meets the fourth quantity of times requirement is the virtual object whose quantity of times of using is largest. A process of determining the quantity of times of using of the virtual object corresponding to each target pick aid request is similar to the foregoing process of determining the quantity of times of ban of the virtual object whose quantity of times of requesting for ban aid meets the first quantity of times requirement. Details are not described herein again in this aspect as described herein.

In some aspects, after the fourth virtual object is determined, the fourth virtual object is used as the virtual object controlled by the first object in the game.

In a possible implementation, object information of pickable virtual objects is further displayed on the second game page. The pickable virtual objects do not include the second virtual object, and the second virtual object is a virtual object banned in the virtual object ban phase in the foregoing aspect. In response to a trigger operation for object information of any pickable virtual object and a triggered pick operation, the pickable virtual object is used as the virtual object controlled by the first object in the game.

In some aspects, a pick control is further displayed on the second game page. In response to a trigger operation for the pick control, a pick operation is triggered. In response to the trigger operation for the object information of any pickable virtual object, the object information of any pickable virtual object is highlighted.

In some aspects, when one pick aid request is received, and a virtual object corresponding to the pick aid request is different from the first virtual object, in response to the end of the virtual object pick phase, and when no pick operation for any virtual object is detected in the virtual object pick phase, a virtual object corresponding to the pick aid request is determined as the virtual object controlled by the first object in the game.

In some aspects, when a plurality of pick aid requests are received, and a virtual object corresponding to each pick aid request is different from the first virtual object, in response to the end of the virtual object pick phase, and when no pick operation for any virtual object is detected in the virtual object pick phase, based on a quantity of times of using of the virtual object corresponding to each pick aid request, a virtual object whose quantity of times of using is largest in virtual objects corresponding to the pick aid requests is determined as the virtual object controlled by the first object in the game.

In some aspects, in response to the end of the virtual object pick phase and when the pick aid request is not received and no pick operation for any virtual object is received in the virtual object pick phase, or in response to the end of the virtual object pick phase and when at least one pick aid request is received, and the first virtual object does not include the virtual object corresponding to each pick aid request, and no pick operation for any virtual object is detected in the virtual object pick phase, a fifth virtual object is determined in the pickable virtual objects, and the fifth virtual object is determined as the virtual object controlled by the first object in the game. In some aspects, any virtual object in the pickable virtual objects is determined as the fifth virtual object, or a virtual object whose quantity of times of using is largest in the pickable virtual objects is determined as the fifth virtual object.

In the foregoing aspects, when the virtual object controlled by the first object in the game is determined, the target pick aid request is first determined in the received pick aid requests, and then the fourth virtual object is determined in the virtual objects corresponding to the target pick aid request. In another aspect, the virtual object controlled by the terminal device can alternatively be determined in another manner. That is, a process of determining the virtual object controlled by the terminal device includes: The terminal device displays a second page corresponding to the virtual object pick phase. The terminal device receives a pick aid request, the pick aid request indicating to assist the first object in picking a virtual object corresponding to the pick aid request. The terminal device determines, in response to the end of the virtual object pick phase and when no pick operation for any virtual object is detected in the virtual object pick phase, the virtual object corresponding to the pick aid request as the virtual object controlled by the terminal device.

In this aspect as described herein, the pick aid request can be received in the virtual object pick phase, and when the virtual object pick phase ends, when the player does not manually pick a virtual object, a controlled virtual object can be automatically picked for the player based on the pick aid request. In this pick aid manner, when the first object leaves, switches a screen, forgets to pick a virtual object, or the like, a virtual object may be picked with the assistance of a teammate. Because in a manner of assisting in picking a virtual object by the teammate, development of an entire game team is considered, a degree of cooperation between objects in the game team can be improved, thereby improving game experience of the game object.

In some aspects, the object information of the first virtual object is displayed on the second game page, and the first virtual object is a candidate virtual object of the terminal device. In this case, a process of determining the virtual object controlled by the terminal device includes: The terminal device determines, in response to the end of the virtual object pick phase and when the pick operation is not detected in the virtual object pick phase and the pick aid request includes the target pick aid request, the virtual object corresponding to the target pick aid request as the virtual object controlled by the terminal device, the virtual object corresponding to the target pick aid request being included in the first virtual object.

In this aspect as described herein, the pick aid request can be received in the virtual object pick phase, and when the virtual object pick phase ends, when the player does not manually pick a virtual object, a controlled virtual object can be automatically picked for the player based on the target pick aid request in the pick aid request, to ensure that the virtual object picked for the player is a virtual object that the player expects to pick, to ensure accuracy of automatically picking a virtual object, thereby improving game experience of the player.

In the foregoing method, in the virtual object ban phase, when the ban aid request is received, the target ban aid request is determined in the received ban aid request based on the virtual object corresponding to the ban aid request and the first virtual object picked by the first object. When the virtual object ban phase ends, and the first object does not manually pick a virtual object that needs to be banned, the second virtual object to be banned is determined based on the virtual object corresponding to the target ban aid request, so as to ban the second virtual object. This virtual object ban manner does not require manual operation of the first object, and can improve efficiency of banning a virtual object, and blank ban does not occur, so that a virtual object ban procedure is complete, thereby improving game experience of the player.

Moreover, when the ban aid request is not received, the first object does not manually pick a virtual object that needs to be banned, and the virtual object ban phase ends, the third virtual object may be determined in the virtual objects that can be banned, so as to ban the third virtual object. In this manner, when the first object does not trigger an operation and a teammate of the first object also does not request for ban aid, a virtual object can also be banned, further ensuring that a blank ban does not occur, and further ensuring completeness of a virtual object ban procedure.

The foregoing implementation is described by using an example in which a client that can provide a virtual environment in the terminal device is the game client. Therefore, the first page in the virtual object ban phase is referred to as the first game page, and the second page corresponding to the virtual object pick phase is referred to as the second game page. In addition, “ban aid” in the foregoing aspects is equivalent to “ban assistance”. In this case, in the foregoing aspects, “ban aid request” is equivalent to “request for ban assistance”, “quantity of times of ban aid” is equivalent to “quantity of times of ban assistance”, “ban aid window” is equivalent to “window of ban assistance”, “ban aid information” is equivalent to “information of ban assistance”, and “ban aid control” is equivalent to “control of ban assistance”. In the foregoing aspects, “pick aid” is equivalent to “pick assistance”, and “pick aid request” is equivalent to “request for pick assistance”.

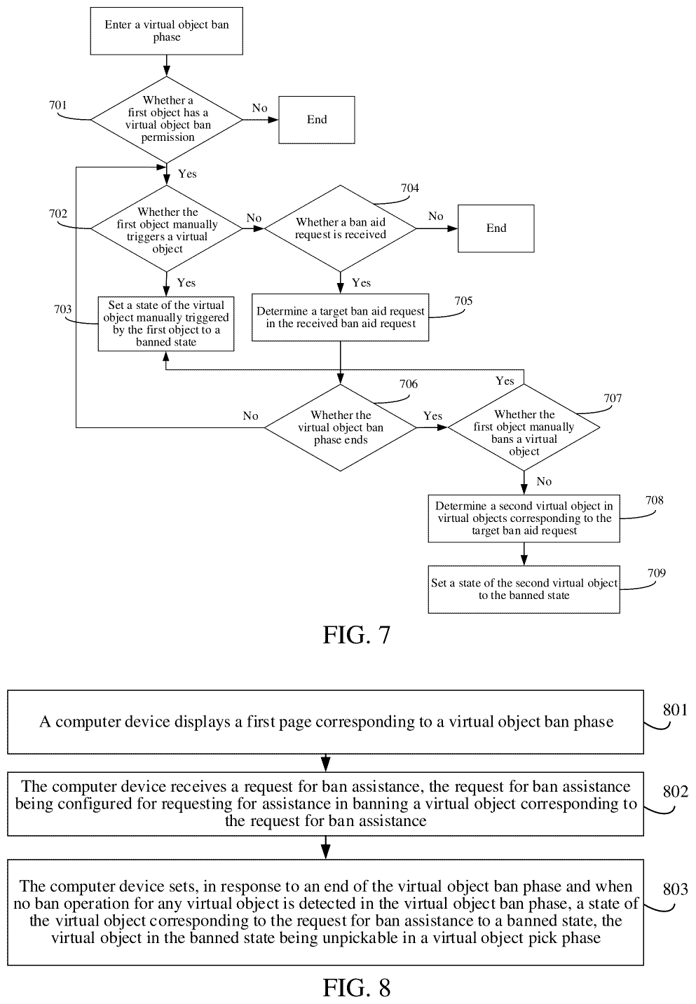

FIG. 7 is a flowchart of a virtual object ban method according to an aspect as described herein. As shown in FIG. 7, the method includes the following operation 701 to operation 709.

Operation 701: Enter a virtual object ban phase, and determine whether a first object has a virtual object ban permission.

Operation 702: Determine whether the first object manually triggers a virtual object when the first object has the virtual object ban permission.

When the first object does not have the virtual object ban permission, a virtual object ban procedure is ended.

Operation 703: Set a state of the virtual object manually triggered by the first object to a banned state when the first object manually triggers the virtual object.

Operation 704: Determine whether a ban aid request is received when the first object does not manually trigger the virtual object.

Operation 705: Determine, when the ban aid request is received, a target ban aid request in the received ban aid request.

A process of determining the target ban aid request in the received ban aid request is described in the foregoing operation 202. Details are not described herein again.

When the ban aid request is not received, the virtual object ban procedure is ended.

Operation 706: Determine whether the virtual object ban phase ends.

Operation 707: Determine whether the first object manually bans the virtual object when the virtual object ban phase ends.

When the virtual object ban phase does not end, operation 702 is performed.

Operation 708: Determine a second virtual object in virtual objects corresponding to the target ban aid request when the first object does not manually ban the virtual object.

A process of determining the second virtual object in the virtual objects corresponding to the target ban aid request is described in the foregoing operation 203. Details are not described herein again.

Operation 709: Set a state of the second virtual object to the banned state.

A process of setting the state of the second virtual object to the banned state is described in the foregoing operation 204. Details are not described herein again.

In the foregoing process of banning the virtual object, an example in which the target ban aid request is first determined, and then the second virtual object is determined in the virtual objects corresponding to the target ban aid request is used for description. In another aspect, a virtual object can alternatively be banned in another manner.

FIG. 8 is a flowchart of a virtual object ban method according to an aspect as described herein. The method is performed by a computer device. As shown in FIG. 8, the method includes the following operation 801 to operation 803.

Operation 801: A computer device displays a first page corresponding to a virtual object ban phase.

The first page is similar to the first game page in the foregoing aspects. Details are not described herein again.

Operation 802: The computer device receives a request for ban assistance, the request for ban assistance being configured for requesting assistance in banning a virtual object corresponding to the request for ban assistance.

The request for ban assistance is similar to the ban aid request in the foregoing aspects. Details are not described herein again.

Operation 803: The computer device sets, in response to an end of the virtual object ban phase and when no ban operation for any virtual object is detected in the virtual object ban phase, a state of the virtual object corresponding to the request for ban assistance to a banned state, the virtual object in the banned state being unpickable in a virtual object pick phase.

In a possible implementation, object information of a first virtual object is displayed on the first page, and the first virtual object is a candidate virtual object of the computer device. Operation 803 includes: The computer device sets, in response to the end of the virtual object ban phase and when the ban operation is not detected in the virtual object ban phase and the request for ban assistance includes a target ban request, a state of a virtual object corresponding to the target request for ban assistance to the banned state, the virtual object corresponding to the target request for ban assistance being different from the first virtual object.

In this aspect as described herein, considering that an object corresponding to the computer device has a virtual object that the object expects to control, that is, the first virtual object, when the virtual object ban phase ends, and when a player object does not manually pick a virtual object that needs to be banned, the virtual object corresponding to the target request for ban assistance is banned based on the received request for ban assistance, to ensure that the banned virtual object is different from the virtual object that the object corresponding to the computer device expects to control. This avoids a case in which the virtual object that the object corresponding to the computer device expects to control is banned, and ensures accuracy of automatically banning a virtual object.

Operation 801 to operation 803 are similar to the foregoing operation 201 to operation 204. Details are not described herein again.

In the solution provided in this aspect as described herein, a virtual object can be banned in the virtual object ban phase, and a request for ban assistance can be received. When the virtual object ban phase ends, and when the player object does not manually pick a virtual object that needs to be banned, a virtual object corresponding to the request for ban assistance is banned. This virtual object ban manner does not require manual operation of the object, and can improve efficiency of banning a virtual object, and blank ban of a virtual object does not occur, so that a virtual object ban procedure is complete, thereby improving game experience of the player.

Based on the foregoing aspects, when a round of game is played, a plurality of terminal devices participating in the same round of game interact with a server, to implement the virtual object ban method. An example in which the terminal devices participating in the same round of game include a first terminal device and a plurality of second terminal devices is used. An object corresponding to the first terminal device and objects corresponding to the plurality of second terminal devices belong to a same game team in the current round of game, which is equivalent to belonging to a same line-up.

For the virtual object ban phase:

When the current round of the game enters the virtual object ban phase, the first terminal device and the plurality of second terminal devices can both display the first page corresponding to the virtual object ban phase. The object corresponding to the first terminal device is referred to as a first object, and the object corresponding to the second terminal device is referred to as a second object. The first object is equivalent to a player using the first terminal device, and the second object is equivalent to a player using the second terminal device. An example in which the first object has a virtual object ban permission is used, and the plurality of second terminal devices can transmit ban aid requests to the first terminal device.

For each second terminal device, the second terminal device displays object information of virtual objects that can be banned on the first page, and transmits, in response to a trigger operation for the object information of any virtual object that can be banned and a triggered ban aid operation, object information of a triggered virtual object to the server, so that the server generates a ban aid request of the second object based on the object information of the triggered virtual object and object information of the second object, and transmits the ban aid request of the second object to the first terminal device.

The first terminal device can receive ban aid requests of a plurality of second objects. In response to the end of the virtual object ban phase and when no ban operation for any virtual object is detected in the virtual object ban phase, based on the foregoing aspects, a virtual object is banned based on the received ban aid requests.

For the virtual object pick phase:

When the current round of game enters the virtual object pick phase, the first terminal device and the plurality of second terminal devices can both display a second page corresponding to the virtual object pick phase. An example in which the plurality of second terminal devices transmits pick aid requests to the first terminal device is used.

For each second terminal device, the second terminal device displays object information of pickable virtual objects on the second page, and transmits, in response to a trigger operation for the object information of any pickable virtual object and a triggered pick aid operation, object information of a triggered virtual object to the server, so that the server generates a pick aid request of the second object based on the object information of the triggered virtual object and object information of the second object, and transmits the pick aid request of the second object to the first terminal device.

The first terminal device can receive pick aid requests of a plurality of second objects. In response to an end of the virtual object pick phase and when no pick operation for any virtual object is detected in the virtual object pick phase, based on the foregoing aspects, a virtual object controlled by the first terminal device is picked based on the received pick aid requests.

In this aspect as described herein, a battle phase is entered after the end of the virtual object pick phase, and each terminal device can control a virtual object of the terminal device to perform activities in a virtual environment.

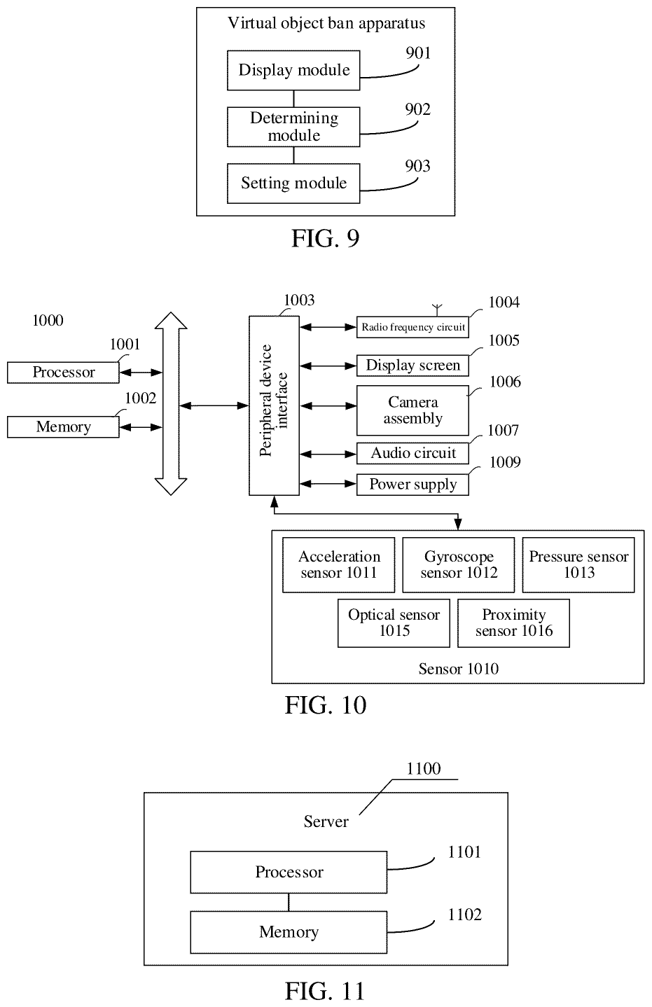

FIG. 9 is a schematic diagram of a structure of a virtual object ban apparatus according to an aspect as described herein. As shown in FIG. 9, the apparatus includes:
a display module 901, configured to display a first game page corresponding to a virtual object ban phase, object information of at least one first virtual object being displayed on the first game page, and the first virtual object being an intended virtual object of a first object participating in a game;
a determining module 902, configured to determine, in response to receiving at least one ban aid request, a target ban aid request in the at least one ban aid request, a virtual object corresponding to any target ban aid request being different from the first virtual object, one ban aid request corresponding to one virtual object, and any ban aid request indicating to request for assistance in banning a virtual object corresponding to any ban aid request, where
the determining module 902 is further configured to determine, in response to that the virtual object ban phase ends and no ban operation for any virtual object is received, a second virtual object in virtual objects corresponding to the target ban aid request; and
a setting module 903, configured to set a state of the second virtual object to a banned state, the second virtual object in the banned state being unpickable in a virtual object pick phase.

In a possible implementation, the determining module 902 is configured to: use, based on that there is one target ban aid request, a virtual object corresponding to the target ban aid request as the second virtual object; determine, based on that there are a plurality of target ban aid requests, a quantity of times of requesting for ban aid of a virtual object corresponding to each target ban aid request; use, based on that there is one virtual object whose quantity of times of requesting for ban aid meets a first quantity of times requirement, the virtual object whose quantity of times of requesting for ban aid meets the first quantity of times requirement as the second virtual object; and determine, based on that there are a plurality of virtual objects whose quantities of times of requesting for ban aid meet the first quantity of times requirement, the second virtual object in the virtual objects whose quantities of times of requesting for ban aid meet the first quantity of times requirement.

In a possible implementation, the determining module 902 is configured to: use any virtual object in the virtual objects whose quantities of times of requesting for ban aid meet the first quantity of times requirement as the second virtual object; or determine a quantity of times of ban of the virtual object whose quantity of times of requesting for ban aid meets the first quantity of times requirement, and use a virtual object whose quantity of times of ban meets a second quantity of times requirement as the second virtual object.

In a possible implementation, the display module 901 is further configured to display a ban aid window corresponding to each target ban aid request, and ban aid information indicating to assist in banning a virtual object corresponding to any target ban aid request is displayed in the ban aid window corresponding to any target ban aid request.

In a possible implementation, object information of the second object is further displayed on the first game page, and the target ban aid request includes object information of an object transmitting the target ban aid request.

The display module 901 is configured to: determine, for any target ban aid request in the target ban aid requests and based on the target ban aid request, object information of an object transmitting the target ban aid request; and display, at a position corresponding to an object transmitting any target ban aid request, a ban aid window corresponding to the target ban aid request.

In a possible implementation, a ban aid control is further displayed in the ban aid window corresponding to each target ban aid request.

The setting module 903 is further configured to set, in response to a trigger operation for a ban aid control displayed in a ban aid window corresponding to any target ban aid request, a virtual object corresponding to any target ban aid request to the banned state, the virtual object corresponding to any target ban aid request in the banned state being unpickable in the virtual object pick phase.

In a possible implementation, object information of a virtual object corresponding to each target ban aid request is further displayed in the ban aid window corresponding to each target ban aid request.

In a possible implementation, the display module 901 is further configured to display first prompt information, the first prompt information indicating to ban the second virtual object.

In a possible implementation, object information of virtual objects that can be banned is further displayed on the first game page.

The determining module 902 is further configured to determine, in response to that the ban aid request is not received and no ban operation for any virtual object is received and the virtual object ban phase ends, a third virtual object in the virtual objects that can be banned.

The setting module 903 is further configured to set a state of the third virtual object to the banned state, the third virtual object in the banned state being unpickable in the virtual object pick phase.

In a possible implementation, the determining module 902 is configured to: use virtual objects other than the first virtual object in the virtual objects that can be banned as candidate banned virtual objects; and use any candidate banned virtual object as the third virtual object; or use a candidate banned virtual object whose quantity of times of ban meets a third quantity of times requirement as the third virtual object.

In a possible implementation, the display module 901 is further configured to display a second game page corresponding to the virtual object pick phase, the object information of the at least one first virtual object being displayed on the second game page.

The determining module 902 is further configured to determine, in response to receiving at least one pick aid request, a target pick aid request in the at least one pick aid request, the at least one first virtual object including a virtual object corresponding to the target pick aid request, one pick aid request corresponding to one virtual object, and any pick aid request indicating to assist the first object in picking a virtual object corresponding to any pick aid request.

The determining module 902 is further configured to determine, in response to that the virtual object pick phase ends and no pick operation for any virtual object is received, a fourth virtual object in virtual objects corresponding to the target pick aid request.

The determining module 902 is further configured to use the fourth virtual object as a virtual object controlled by the first object in the game.

In the foregoing apparatus, in the virtual object ban phase, when the ban aid request is received, the target ban aid request is determined in the received ban aid request based on the virtual object corresponding to the ban aid request and the first virtual object picked by the first object. When the virtual object ban phase ends, and the first object does not manually pick a virtual object that needs to be banned, the second virtual object to be banned is determined based on the virtual object corresponding to the target ban aid request, so as to ban the second virtual object. This virtual object ban manner does not require manual operation of the first object, and can improve efficiency of banning a virtual object, and blank ban does not occur, so that a virtual object ban procedure is complete, thereby improving game experience of the player.

Based on the aspect shown in FIG. 9, the display module, the determining module, and the setting model in the virtual object ban apparatus provided in this aspect as described herein further have the following functions.

The display module is configured to display a first page corresponding to the virtual object ban phase.

The determining module is configured to receive a request for ban assistance, the request for ban assistance being configured for requesting assistance in banning a virtual object corresponding to the request for ban assistance.

The setting module is configured to set, in response to an end of the virtual object ban phase and when no ban operation for any virtual object is detected in the virtual object ban phase, a state of the virtual object corresponding to the request for ban assistance to the banned state, the virtual object in the banned state being unpickable in the virtual object pick phase.

In a possible implementation, the object information of the first virtual object is displayed on the first page, and the first virtual object is a candidate virtual object of the local end. The setting module is configured to set, in response to the end of the virtual object ban phase and when the ban operation is not detected in the virtual object ban phase and the request for ban assistance includes a target ban request, a state of a virtual object corresponding to the target request for ban assistance to the banned state, the virtual object corresponding to the target request for ban assistance being different from the first virtual object.

In a possible implementation, the setting module is configured to: set, in response to the end of the virtual object ban phase and when the ban operation is not detected in the virtual object ban phase and the request for ban assistance includes one target request for ban assistance, a state of a virtual object corresponding to the target request for ban assistance to the banned state; or

determine, in response to the end of the virtual object ban phase and when the ban operation is not detected in the virtual object ban phase and the request for ban assistance includes a plurality of target requests for ban assistance, a quantity of times of requesting for ban assistance of a virtual object corresponding to each target request for ban assistance; set, when there is one virtual object whose quantity of times of requesting for ban assistance meets the first quantity of times requirement, a state of the virtual object whose quantity of times of requesting for ban assistance meets the first quantity of times requirement to the banned state; determine, when there are a plurality of virtual objects whose quantities of times of requesting for ban assistance meet the first quantity of times requirement, the second virtual object in the virtual objects whose quantities of times of requesting for ban assistance meet the first quantity of times requirement; and set the state of the second virtual object to the banned state.

In a possible implementation, the setting module is configured to: determine any virtual object in the virtual objects whose quantities of times of requesting for ban assistance meet the first quantity of times requirement as the second virtual object; or

determine the quantity of times of ban of the virtual object whose quantity of times of requesting for ban assistance meets the first quantity of times requirement; and determine the virtual object whose quantity of times of ban meets the second quantity of times requirement as the second virtual object.

In a possible implementation, the display module is further configured to display a window of ban assistance corresponding to the request for ban assistance, information of ban assistance being displayed in the window of ban assistance, and the information of ban assistance indicating to ban the virtual object corresponding to the request for ban assistance.

In a possible implementation, the request for ban assistance includes object information of a target object, and the target object is an object transmitting the request for ban assistance. The display module is configured to display, at a position corresponding to the target object based on the object information in the request for ban assistance, the window of ban assistance corresponding to the request for ban assistance.

In a possible implementation, the object information of the target object is displayed on the first page. The display module is configured to display, at a display position of the object information of the target object based on the object information in the request for ban assistance, the window of ban assistance corresponding to the request for ban assistance.

In a possible implementation, a control of ban assistance is further displayed in the window of ban assistance. The setting module is further configured to set, in response to a trigger operation for the control of ban assistance, the state of the virtual object corresponding to the request for ban assistance to the banned state.

In a possible implementation, object information of the virtual object corresponding to the request for ban assistance is further displayed in the window of ban assistance corresponding to the request for ban assistance.

In a possible implementation, the display module is further configured to display the first prompt information, the first prompt information indicating that the virtual object corresponding to the request for ban assistance is banned.

In a possible implementation, the object information of the virtual objects that can be banned is further displayed on the first page.

The determining module is further configured to determine, in response to the end of the virtual object ban phase and when the request for ban assistance is not received and no ban operation for any virtual object is detected in the virtual object ban phase, the third virtual object in the virtual objects that can be banned.

The setting module is further configured to set the state of the third virtual object to the banned state.

In a possible implementation, the determining module is configured to: determine the virtual objects other than the first virtual object in the virtual objects that can be banned as the candidate banned virtual objects; and

determine any candidate banned virtual object as the third virtual object; or determine the candidate banned virtual object whose quantity of times of ban meets the third quantity of times requirement as the third virtual object.

In a possible implementation, the display module is further configured to display a second page corresponding to the virtual object pick phase.

The determining module is further configured to: receive a request for pick assistance, the request for pick assistance indicating to assist in picking a virtual object corresponding to the request for pick assistance; and determine, in response to an end of the virtual object pick phase and when no pick operation for any virtual object is detected in the virtual object pick phase, the virtual object corresponding to the request for pick assistance as a virtual object controlled by the local end.

In a possible implementation, the object information of the first virtual object is displayed on the second page, and the first virtual object is the candidate virtual object of the local end. The determining module is configured to determine, in response to the end of the virtual object pick phase and when the pick operation is not detected in the virtual object pick phase and the request for pick assistance includes a target request for pick assistance, a virtual object corresponding to the target request for pick assistance as the virtual object controlled by the local end, the virtual object corresponding to the target request for pick assistance being included in the first virtual object.

When the apparatus provided above implements the functions of the apparatus, only division into the foregoing functional modules is used as an example for description. In an actual application, the functions may be allocated to and completed by different functional modules based on requirements. That is, an internal structure of the device is divided into different functional modules, to complete all or some of the functions described above. In addition, the apparatus and method aspects provided in the foregoing aspects belong to a same concept. FIG. 10 is a block diagram of a structure of a terminal device 1000 according to an illustrative aspect as described herein. The terminal device 1000 is any electronic device product that may perform human-computer interaction with a user in one or more manners such as a keyboard, a touchpad, a remote control, voice interaction, or a handwriting device, for example, a personal computer (PC), a mobile phone, a smartphone, a personal digital assistant (PDA), a wearable device, a pocket PC (PPC), a tablet computer, a smart on board unit, a smart television, a smart speaker, or a smart watch.

Generally, the terminal device 1000 includes a processor 1001 and a memory 1002.

The processor 1001 may include one or more processing cores such as a 4-core processor or an 8-core processor. The processor 1001 may be implemented in at least one hardware form of digital signal processing (DSP), a field-programmable gate array (FPGA), and a programmable logic array (PLA). The processor 1001 may alternatively include a main processor and a coprocessor. The main processor is a processor configured to process data in an awake state, and is also referred to as a central processing unit (CPU). The coprocessor is a low power consumption processor configured to process the data in a standby state. In some aspects, the processor 1001 may be integrated with a graphics processing unit (GPU). The GPU is configured to render and draw content that needs to be displayed on a display screen. In some aspects, the processor 1001 may further include an artificial intelligence (AI) processor. The AI processor is configured to process computing operations related to machine learning.

The memory 1002 may include one or more computer-readable storage media. The computer-readable storage medium may be non-transient. The memory 1002 may further include a high-speed random access memory and a non-volatile memory, for example, one or more disk storage devices or flash storage devices. In some aspects, the non-transient computer-readable storage medium in the memory 1002 is configured to store at least one instruction, and the at least one instruction is executed by the processor 1001 to implement the virtual object ban method provided in method aspects as described herein.

In some aspects, the terminal device 1000 may alternatively include a peripheral device interface 1003 and at least one peripheral device. The processor 1001, the memory 1002, and the peripheral device interface 1003 may be connected through a bus or a signal line. Each peripheral device may be connected to the peripheral device interface 1003 through a bus, a signal line, or a circuit board. Specifically, the peripheral device includes at least one of a radio frequency circuit 1004, a display screen 1005, a camera assembly 1006, an audio circuit 1007, and a power supply 1009.

The peripheral device interface 1003 may be configured to connect the at least one peripheral device related to input/output (I/O) to the processor 1001 and the memory 1002. In some aspects, the processor 1001, the memory 1002, and the peripheral device interface 1003 are integrated on a same chip or circuit board. In some other aspects, any one or two of the processor 1001, the memory 1002, and the peripheral device interface 1003 may be implemented on a single chip or circuit board, which is not limited in aspects.

The radio frequency circuit 1004 is configured to receive and transmit a radio frequency (RF) signal, which is also referred to as an electromagnetic signal. The radio frequency circuit 1004 communicates with a communication network and another communication device through the electromagnetic signal. The radio frequency circuit 1004 converts an electric signal into an electromagnetic signal for transmission, or converts a received electromagnetic signal into an electric signal. In some aspects, the radio frequency circuit 1004 includes an antenna system, an RF transceiver, one or more amplifiers, a tuner, an oscillator, a digital signal processor, a codec chip set, a subscriber identity module card, and the like. The radio frequency circuit 1004 may communicate with another terminal device through at least one wireless communication protocol. The wireless communication protocol includes but is not limited to a world wide web, a metropolitan area network, an intranet, generations of mobile communication networks (2G, 3G, 4G, and 5G), a wireless local area network and/or a wireless fidelity (Wi-Fi) network. In some aspects, the radio frequency circuit 1004 may further include a circuit related to near field communication (NFC), which is not limited as described herein.

The display screen 1005 is configured to display a user interface (UI). The UI may include a graph, text, an icon, a video, and any combination thereof. When the display screen 1005 is a touch display screen, the display screen 1005 further has a capability of acquiring a touch signal on or above a surface of the display screen 1005. The touch signal may be inputted to the processor 1001 as a control signal for processing. In this case, the display screen 1005 may be further configured to provide a virtual button and/or a virtual keyboard, also referred to as a soft button and/or a soft keyboard. In some aspects, there may be one display screen 1005, disposed on a front panel of the terminal device 1000. In some other aspects, there may be at least two display screens 1005, respectively disposed on different surfaces of the terminal device 1000 or designed in a foldable shape. In still some other aspects, the display screen 1005 may be a flexible display screen, disposed on a curved surface or a folded surface of the terminal device 1000. Even, the display screen 1005 may be further provided in a non-rectangular irregular pattern, i.e., a special-shaped screen. The display screen 1005 may be prepared using materials such as a liquid crystal display (LCD) and an organic light-emitting diode (OLED).

The camera assembly 1006 is configured to acquire images or videos. In some aspects, the camera assembly 1006 includes a front camera and a rear camera. Generally, the front camera is disposed on the front panel of the terminal device 1000, and the rear camera is disposed on a back surface of the terminal device 1000. In some aspects, there are at least two rear cameras, which are respectively any one of a main camera, a depth-of-field camera, a wide-angle camera, and a telephoto camera, to implement a background blur function through fusion of the main camera and the depth-of-field camera, panoramic photographing and virtual reality (VR) photographing functions through fusion of the main camera and the wide-angle camera, or other fusion photographing functions. In some aspects, the camera assembly 1006 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1007 may include a microphone and a speaker. The microphone is configured to acquire sound waves of a user and an environment, and convert the sound waves into electrical signals to input to the processor 1001 for processing, or input to the radio frequency circuit 1004 for implementing voice communication. For the purpose of stereo acquisition or noise reduction, there may be a plurality of microphones, respectively provided at different portions of the terminal device 1000. The microphone may alternatively be an array microphone or an omni-directional acquisition type microphone. The speaker is configured to convert electrical signals from the processor 1001 or the radio frequency circuit 1004 into sound waves. The speaker may be a conventional film speaker, or may be a piezoelectric ceramic speaker. When the speaker is the piezoelectric ceramic speaker, the speaker not only can convert electric signals into acoustic waves audible to a human being, but also can convert electric signals into acoustic waves inaudible to a human being, for ranging and other purposes. In some aspects, the audio circuit 1007 may further include an earphone jack.

The power supply 1009 is configured to supply power to assemblies in the terminal device 1000. The power supply 1009 may be an alternating current, a direct current, a primary battery, or a rechargeable battery. When the power supply 1009 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some aspects, the terminal device 1000 further includes one or more sensors 1010. The one or more sensors 1010 include but are not limited to an acceleration sensor 1011, a gyroscope sensor 1012, a pressure sensor 1013, an optical sensor 1015, and a proximity sensor 1016.

A person skilled in the art may understand that the structure shown in FIG. 10 constitutes no limitation on the terminal device 1000, and the terminal device may include more or fewer assemblies than those shown in the figure, or some assemblies may be combined, or a different assembly deployment may be used.

FIG. 11 is a schematic diagram of a structure of a server according to an aspect as described herein. The server 1100 may vary a lot due to different configurations or performance, and may include one or more processors (CPUs) 1101 and one or more memories 1102. The one or more memories 1102 store at least one piece of program code, and the at least one piece of program code is loaded and executed by the one or more processors 1101 to implement the virtual object ban method provided in the foregoing method aspects. The server 1100 may further have components such as a wired or wireless network interface, a keyboard, and an I/O interface for inputting and outputting. The server 1100 may further include other components configured to implement device functions. Details are not described herein.

In an illustrative aspect, a computer-readable storage medium is further provided. The storage medium stores at least one piece of program code, and the at least one piece of program code is loaded and executed by a processor, to enable a computer to implement any one of the foregoing virtual object ban methods.

In some aspects, the foregoing computer-readable storage medium may be a read-only memory (ROM), a random access memory (RAM), a compact disc read-only memory (CD-ROM), a magnetic tape, a floppy disk, an optical data storage device, or the like.

In an illustrative aspect, a computer program or a computer program product is further provided. The computer program or the computer program product stores at least one computer instruction, and the at least one computer instruction is loaded and executed by a processor, to enable a computer to implement any one of the foregoing virtual object ban methods.

Information (including but not limited to user equipment information, user personal information, and the like), data (including but not limited to data for analysis, data for storage, data for display, and the like), and signals involved as described herein are all authorized by users or fully authorized by all parties, and collection, use, and processing of relevant data need to comply with relevant laws, regulations, and standards of relevant regions. For example, the object information as described herein is obtained under full authorization.

“Plurality of” mentioned in the specification means two or more. “And/or” describes an association relationship of associated objects and represents that three relationships may exist. For example, A and/or B may represent the following three cases: Only A exists, both A and B exist, and only B exists. The character “/” in this specification usually indicates an “or” relationship between the associated objects.

The sequence numbers of the foregoing aspects as described herein are merely for description but do not imply the preference among aspects.

The foregoing descriptions are merely illustrative aspects as described herein, but are not intended to limit this application. Any modification, equivalent replacement, or improvement made within the principle as described herein shall fall within the protection scope as described herein.

What is claimed is:

1. A computer-implemented method comprising:
displaying, by a computer device, a first page corresponding to a virtual object ban phase;
receiving, by the computer device, a request for ban assistance, the request for ban assistance being configured for requesting assistance in banning a virtual object corresponding to the request for ban assistance; and
setting, by the computer device in response to an end of the virtual object ban phase and when no ban operation for any virtual object is detected in the virtual object ban phase, a state of the virtual object corresponding to the request for ban assistance to a banned state, the virtual object in the banned state being unpickable in a virtual object pick phase.

2. The method of claim 1, wherein object information of a first virtual object is displayed on the first page, and the first virtual object is a candidate virtual object of the computer device; and the setting comprises:
setting, when the request for ban assistance comprises a target ban request, a state of a virtual object corresponding to the target ban request to the banned state, the virtual object corresponding to the target ban request being different from the first virtual object.

3. The method of claim 2, wherein the setting the state of the virtual object corresponding to the target request for ban assistance to the banned state comprises:
setting, when the request for ban assistance comprises one target request for ban assistance, a state of a virtual object corresponding to the one target request for ban assistance to the banned state; and
determining, when the request for ban assistance comprises a plurality of target requests for ban assistance, a quantity of times of requesting for ban assistance of a virtual object corresponding to each target request for ban assistance; setting, when there is one virtual object whose quantity of times of requesting for ban assistance meets a first quantity of times requirement, a state of the virtual object whose quantity of times of requesting for ban assistance meets the first quantity of times requirement to the banned state; determining, when there are a plurality of virtual objects whose quantities of times of requesting for ban assistance meet the first quantity of times requirement, a second virtual object in the virtual objects whose quantities of times of requesting for ban assistance meet the first quantity of times requirement; and setting a state of the second virtual object to the banned state.

4. The method of claim 3, wherein the determining the second virtual object in the virtual objects whose quantities of times of requesting for ban assistance meet the first quantity of times requirement comprises:
determining a quantity of times of ban of the virtual object whose quantity of times of requesting for ban assistance meets the first quantity of times requirement; and determining a virtual object whose quantity of times of ban meets a second quantity of times requirement as the second virtual object.

5. The method of claim 1, wherein after the receiving, the method further comprises:
displaying, by the computer device, a window of ban assistance corresponding to the request for ban assistance, indicating that the virtual object corresponding to the request for ban assistance will be banned.

6. The method of claim 1, wherein the request for ban assistance comprises object information of a target object, and the target object is an object transmitting the request for ban assistance; and
the displaying, by the computer device, a window of ban assistance corresponding to the request for ban assistance comprises:
displaying, by the computer device based on the object information in the request for ban assistance and at a position corresponding to the target object, the window of ban assistance corresponding to the request for ban assistance.

7. The method of claim 6, wherein the object information of the target object is displayed on the first page; and the displaying the window of ban assistance corresponding to the request for ban assistance comprises:
displaying, by the computer device based on the object information in the request for ban assistance and at a display position of the object information of the target object, the window of ban assistance corresponding to the request for ban assistance.

8. The method of claim 1, wherein a control of ban assistance is further displayed in the window of ban assistance; and
after the displaying, by the computer device, the window of ban assistance, the method further comprises:
setting, by the computer device in response to a trigger operation for the control of ban assistance, the state of the virtual object corresponding to the request for ban assistance to the banned state.

9. The method of claim 1, wherein object information of the virtual object corresponding to the request for ban assistance is further displayed in the window of ban assistance corresponding to the request for ban assistance.

10. The method of claim 1, wherein after the setting the method further comprises:
displaying, by the computer device, first prompt information, the first prompt information indicating that the virtual object corresponding to the request for ban assistance is banned.

11. The method of claim 1, wherein object information of virtual objects that can be banned is further displayed on the first page; and
after the displaying, the method further comprises:
determining, by the computer device in response to the end of the virtual object ban phase and when the request for ban assistance is not received and no ban operation for any virtual object is detected in the virtual object ban phase, a third virtual object in the virtual objects that can be banned; and
setting, by the computer device, a state of the third virtual object to the banned state.

12. The method of claim 11, wherein the determining the third virtual object comprises:
determining virtual objects other than the first virtual object in the virtual objects that can be banned as candidate banned virtual objects; and
determining any candidate banned virtual object as the third virtual object; or determining a candidate banned virtual object whose quantity of times of ban meets a third quantity of times requirement as the third virtual object.

13. The method of claim 1, wherein after the setting, the method further comprises:
displaying, by the computer device, a second page corresponding to the virtual object pick phase;
receiving, by the computer device, a request for pick assistance indicating to assist the computer device in picking a virtual object corresponding to the request for pick assistance; and
determining, by the computer device in response to an end of the virtual object pick phase and when no pick operation for any virtual object is detected in the virtual object pick phase, the virtual object corresponding to the request for pick assistance as a virtual object controlled by the computer device.

14. The method of claim 13, wherein the object information of the first virtual object is displayed on the second page, and the first virtual object is the candidate virtual object of the computer device; and the determining the virtual object corresponding to the request for pick assistance comprises:
determining, by the computer device in response to the end of the virtual object pick phase and when the pick operation is not detected in the virtual object pick phase and the request for pick assistance comprises a target request for pick assistance, a virtual object corresponding to the target request for pick assistance as the virtual object controlled by the computer device, the virtual object corresponding to the target request for pick assistance being comprised in the first virtual object.

15. One or more non-transitory computer readable media comprising computer readable instructions that, when executed by a processor, configure a data processing system to perform:
displaying, by a computer device, a first page corresponding to a virtual object ban phase;
receiving, by the computer device, a request for ban assistance, the request for ban assistance requesting assistance in banning a virtual object corresponding to the request for ban assistance; and
setting, by the computer device in response to an end of the virtual object ban phase and when no ban operation for any virtual object is detected in the virtual object ban phase, a state of the virtual object corresponding to the request for ban assistance to a banned state, the virtual object in the banned state being unpickable in a virtual object pick phase.

16. The computer readable media of claim 15, wherein object information of a first virtual object is displayed on the first page, and the first virtual object is a candidate virtual object of the computer device; and the setting comprises:
setting, when the request for ban assistance comprises a target ban request, a state of a virtual object corresponding to the target ban request to the banned state, the virtual object corresponding to the target ban request being different from the first virtual object.

17. The computer readable media of claim 16, wherein the setting the state of the virtual object corresponding to the target request for ban assistance to the banned state comprises:
setting, when the request for ban assistance comprises one target request for ban assistance, a state of a virtual object corresponding to the one target request for ban assistance to the banned state; and
setting, when the request for ban assistance comprises a plurality of target requests for ban assistance, a state of only one virtual object corresponding to a selected target request to the banned state.

18. The computer readable media of claim 17, wherein the selected target request is selected by:
determining a quantity of times that each virtual object corresponding to each of the plurality of target requests has been requested to be banned;
setting, when there is only one virtual object whose quantity of times meets a first predetermined requirement, a state of the one virtual object to the banned state;
setting, when a plurality of virtual objects have corresponding quantities of times meeting the first predetermined requirement, only one of the virtual objects to the banned state.

19. A system comprising: a processor, and memory storing computer readable instructions that, when executed by the processor, configure the system to perform:
displaying, by the system, a first page corresponding to a virtual object ban phase;
receiving, the system, a request for ban assistance, the request for ban assistance requesting assistance in banning a virtual object corresponding to the request for ban assistance; and
setting, by the system in response to an end of the virtual object ban phase and when no ban operation for any virtual object is detected in the virtual object ban phase, a state of the virtual object corresponding to the request for ban assistance to a banned state, the virtual object in the banned state being unpickable in a virtual object pick phase.

20. The system of claim 19, wherein object information of a first virtual object is displayed on the first page, and the first virtual object is a candidate virtual object of the computer device; and the setting comprises:
setting, when the request for ban assistance comprises a target ban request, a state of a virtual object corresponding to the target ban request to the banned state, the virtual object corresponding to the target ban request being different from the first virtual object.
